(19) United States
(12) Patent Application Publication
(10) Pub. No.: US 2012/0177833 A1
(43) Pub. Date: Jul. 12, 2012

(54) Method for applying defined-character, anti-projectile, anti-leak barrier coating

(75) Inventors: Thomas S. Ohnstad, Salem, OR (US); Russell A. Monk, Salem, OR (US)

(73) Assignee: High Impact Technology, L.L.C.

(21) Appl. No.: 12/380,361

(22) Filed: Feb. 25, 2009

Related U.S. Application Data
(63) Continuation of application No. 11/412,473, filed on Apr. 26, 2006, now abandoned.
(60) Provisional application No. 60/678,111, filed on May 3, 2005.
(60) Provisional application No. 60/683,998, filed on May 24, 2005.

(51) Int. Cl. B05D 1/36

(52) U.S. Cl. 427/407.1

(57) ABSTRACT

A method for applying to an outside surface of a liquid container an anti-leak, self-healing, layered barrier structure intended to inhibit liquid leakage from that container due to an impacting and piercing projectile. The method includes the steps of (a) spray applying to the mentioned container surface a first barrier layer formed of a high-elastomeric material, (b) thereafter, spray applying to the first barrier layer a second, composite-material barrier layer including a body formed of substantially the same high-elastomeric material used in the first barrier layer, and a distribution in that body of a plurality of liquid-imbiber bead elements designed to react with dimensional swelling and related liquid absorption when contacted by any leakage fluid coming from the mentioned container, and (c) thereafter, spray-applying to the second barrier layer a third barrier layer formed of substantially the same high-elastomeric material used in the mentioned first barrier layer, and in the body of the second, composite barrier layer.

### CROSS REFERENCES TO RELATED APPLICATIONS

This application is a continuation of currently co-pending Regular U.S. patent application Ser. No. 11/412,473, filed Apr. 26, 2006, for “Method For Applying Defined-Character, Anti-Projectile, Ante-Leak Barrier Coating”, which regular application claims priority, respectively, to the filing dates of two then currently pending, previously filed U.S. Provisional Patent Applications. These two prior-filed, provisional applications include Ser. No. 60/678,111, filed May 3, 2005 for “Method for Applying Anti-Leak Barrier Coating”, and Ser. No. 60/683,998, filed May 24, 2005 for “Application of Plural-Component, Self-Healing, Anti-Puncture Liquid Container Coating With Staged, Selective Component Blending”. The full disclosure contents of each of these three prior-filed applications are hereby incorporated herein by reference.

### BACKGROUND AND SUMMARY OF THE INVENTION

This invention pertains to methodology relating to applying, to an outside surface of a liquid container, a special, plural-layer, anti-leak, self-healing, anti-projectile-puncture, barrier structure which, using several different mechanisms, is intended inhibit liquid leakage from a selected container due to an impacting and piercing projectile, such as a bullet. An earlier version of this barrier structure is described in U.S. patent application Ser. No. 11/067,525, filed Feb. 25, 2005 for “Projectile Barrier and Method”, and reference is made herein to that prior-filed patent application for the purpose of setting forth a background foundation relevant to the present invention.

We have determined that, for such an application, a very suitable barrier structure, or coating, is formed with three layers, including two outer layers which are made of an appropriate high-elastomeric material, and the third layer which is sandwiched between the two outer layers, formed as a composite-material layer including a body of substantially the same kind of high-elastomeric material just mentioned, in which body there exists a distribution of plural liquid-imbiber beads specifically designed to react, in a material-congealing and three-dimensional swelling manner, to contact with any liquid which might leak from a puncture created in a container of the type generally mentioned above. Even more specifically, we have determined that such a three-layer barrier structure may advantageously be constructed in such a fashion that the layer thicknesses of the two, outer, elastomeric layers are the same, with this thickness being substantially twice that of the intermediate layer which contains the mentioned beads.

Fundamentally, the methodology of the present invention features generally two different layer-application procedures, one of which is associated with the creation of the two high-elastomeric only layers, and the second of which involves application of the intermediate, composite layer. The preferred manner for implementing the layer-creating procedures involves spray-application of the relevant layer-forming materials.

The various features and advantages of the present invention will become more fully apparent as the detailed description which now follows is read in conjunction with the accompanying drawings.

### DESCRIPTION OF THE DRAWINGS

FIG. 1 illustrates a fragmentary cross section of a plural-layer barrier structure which has been formed in accordance with practice of the present invention. This barrier structure is shown in place on the surface of a metallic liquid container, such as on the surface of a steel fuel-carrying tank in a military fuel truck.

FIG. 2 is a fragmentary, block/schematic diagram illustrating three different specific manners for implementing the methodology of the present invention.

### DETAILED DESCRIPTION OF THE INVENTION

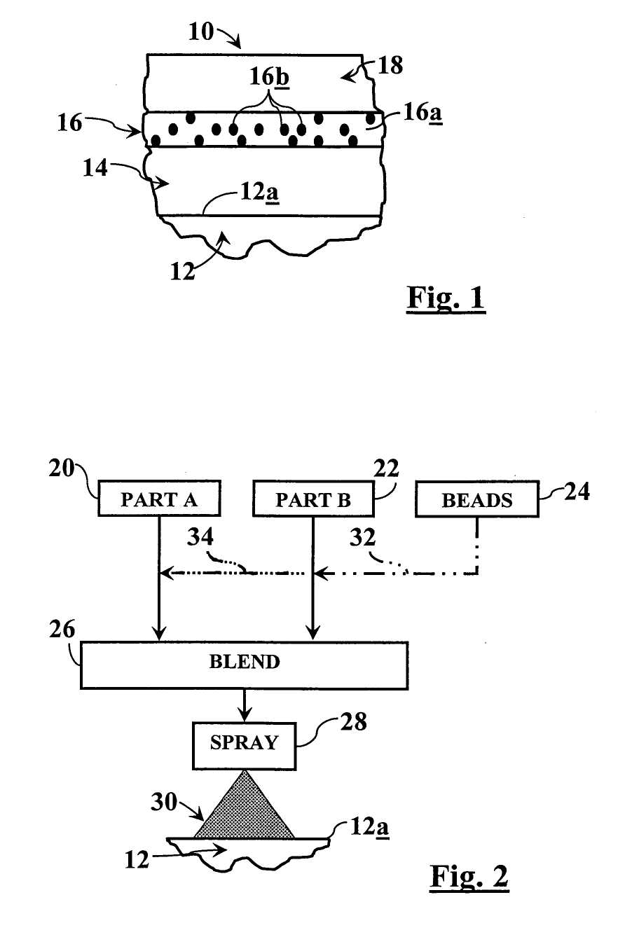

Turning now to the drawings, and beginning first of all with FIG. 1, indicated generally at 10, disposed on the outside surface 12a of a steel liquid-containing tank 12, is a three-layer barrier structure 10, including an inner layer 14, an intermediate layer 16, and an outer layer 18, all of which have been prepared in accordance with practice of the present invention. For the purpose of illustrating the present invention, container 12 takes the form of a hydrocarbon fuel-carrying tank in a military fuel supply tank truck, and barrier structure 10 has been applied to the outside of this container to defeat any fuel leakage which might occur through a ballistic-impact puncturing of container 12, as by a fired bullet.

Interposed inner layer 14 and tank surface 12a is an appropriate (but not illustrated) thin primer layer which aids in bonding layer 14 to surface 12a. More will be said about this primer layer shortly.

Within barrier structure 10, layers 14 and 18 each has a layer thickness of about ¼-inches, with each of these two layers being formed of a spray-applied high-elastomeric material, such as the material known as TUFF STUFF®, made by Rhino Linings USA, Inc. in San Diego, Calif. This particular high-elastomeric material, which has proven to be very effective for use in the practice of the present invention, takes the form of a catalytically cured, two-component, or two-part, material having parts referred to herein simply as parts A and B which become blended prior to spray-application of the resulting, blended high-elastomeric material. These blended parts react with one another after blending to form a rapidly curing high-elastomeric mass. In relation to the specific high-elastomeric material just generally described above, part A takes the form of Rhino Part No. 60012, and part B takes the form of Rhino Part No. 60058 (now identified as Rexar MT FR 85-15, product number 60080).

Layer 16, which lies sandwiched between layers 14, 18 as an intermediate layer, has a thickness herein of about ⅛-inches, and is formed as a composite material including a body 16a of the same high-elastomeric material used in layers 14, 16, and a distribution in this body of a plurality of liquid-imbiber beads, or elements, 16b. In the specific barrier structure now being described, these imbiber beads are formed of a product called IMB230300, made by Imbibitive Technologies America, Inc. in Midland, Mich. These beads are specifically reactive with respect to contact with hydrocarbon fuel, and on such contact, they respond by absorbing contacting fuel, and growing (swelling) in size as a consequence of that absorbing action. Within layer 16, beads 16b make up about 22 percent by volume of layer 16.

When a projectile, such as a bullet, impacts the arrangement shown in FIG. 1, if that bullet penetrates the wall of container 12, and fuel held within the container begins to leak through the puncture wound thus created, the materials in layers 14, 16, 18 respond quickly with both elastomeric and material(dimensional)-swelling reactions to close off the wound passage speedily to prevent any major fuel leak from taking place. In addition to the elastomeric and dimensional-swelling mechanisms just mentioned, the materials making up layers 14, 16, 18, on contact with leaking fuel, tend to react additionally to form a kind of tacky, coagulating mass of material which further aids in sealing the puncture wound which has been created.

Turning attention now to FIG. 2, here, two different specific ways of creating the three layers in barrier structure 10 are illustrated schematically. Blocks 20, 22 in FIG. 2 represent appropriate pre-blend containers of parts A and B, respectively, which are combined to form the above-mentioned high-elastomeric material. Block 24 represents an appropriate pre-blend container of a supply of the liquid-imbiber beads mentioned above. Block 26 represents an appropriate instrumentality for implementing a blending function, and block 28 represents a suitable, single-spray-head spray device to which a blend of materials is delivered from instrumentality 26 to device 28 for creating an appropriate spray such as that shown generally at 30 in FIG. 2.

As was mentioned earlier, FIG. 2 is employed herein to illustrate three different specific manners for implementing the methodology of the present invention. These manners relate to three different ways in which liquid-imbiber beads may be introduced for blending with the high-elastomeric materials prior to spray-application for creation of composite layer 16. In the creation of layers 14 and 18, of course, no liquid-imbiber beads are added to the spray mixture.

As can be seen in FIG. 2, liquid-imbiber beads are appropriately added in one of three different ways immediately upstream from where materials are delivered to block 26. One way for delivering such beads is represented by dash-double-dot, arrow-headed line 32 which represents the addition of beads into the flow of elastomeric part B only on its way toward block 26.

A second way of introducing the liquid-imbiber beads is to introduce them only to the flow of part A of the elastomer material on its route to block 26, and this way is represented collectively by previously mentioned line 32, and a dash-triple-dot, arrow-headed line 34 in FIG. 2, recognizing, of course, that no beads are introduced during this approach to the flow of elastomeric part B.

A third way of introducing the liquid-imbiber beads involves flowing these beads simultaneously to the flows of both of the A/B elastomeric-material flows.

During creation of layers 14, 18, as was just above mentioned, no liquid-imbiber beads are added to the flowing and blended parts A and B of the elastomeric material. Thus, during the formation of these two elastomeric-material-only layers, spray 30 simply takes the form of a blend of elastomer parts A and B. When, however, a composite layer, like layer 16, is to be created, imbiber beads are added appropriately upstream from block 26 to become part of the overall blend of materials delivered for spraying by device 28. In this case, an output spray, like spray 30, includes, in addition to the two blended elastomeric parts A and B, liquid-imbiber beads, such as those represented by darkened dots within the outline of spray 30 in FIG. 2.

In any suitable fashion, which does not form any part of the present invention inasmuch as various conventional approaches may be employed, with respect to the creation of a composite-material layer, such as layer 16, beads are added in such a manner that, within the resulting output spray 30, the beads make up about 22-percent by volume of the spray which is directed toward container 12. This spray, of course, is one which creates such a composite-material layer directly on a previously formed elastomeric-material-only layer, such as layer 14 shown in FIG. 1.

With respect to spray application and creation of the several barrier-structure (coating) layers that are associated with implementation and practice of this invention, a word here about the use of a “receiving-surface” primer for layer adhesion assistance will be useful.

Where the receiving surface is either metal, or painted metal, that surface, such as surface 12a, should be completely dry before primer application. For an unpainted metal surface, normally no special surface texturing is necessary before primer application. However, where painted metal is involved, paint-surface profiling to produce about a 1- to about a 3-mil texture is recommended.

To such a surface, an appropriate primer, such as the so-called System 251 primer made by Rhino Linings, USA, Inc. (mentioned earlier herein), may be used. This primer preferably is applied to create a primer layer having a thickness lying in the range of about 2- to about 5-mils. Manufacturer's instructions are entirely adequate to describe both the details of applying this primer to different surfaces, and the conditions which, after primer application, should be observed to indicate readiness of the primer to receive a sprayed overlayer, such as the innermost elastomeric layer discussed herein which lies closest to the outer surface of a protected liquid container.

After application of this innermost elastomeric layer, and with regard to the recommended use or non-use of such a primer in an interlayer manner as successive barrier-structure layers, such as layers are sprayed into place, we have found that no primer is needed if the relevant interlayer spray interval is less than about 4-hours. If such an interval is greater than about 4-hours, primer use is recommended. The same System 251 primer may be used for such interlayer conditions.

Where the receiving surface for the innermost, barrier-structure elastomeric layer is the outer surface of a plastic container, such as the outer surface of an HDPE fuel tank in a military vehicle, two things preferably should be done to prepare such a surface for elastomeric layer receipt. First, the surface should be scrubbed/scuffed, as with a rotary wire cup brush, to roughen the surface, and to remove any “surface gloss” of this surface. Next, an appropriate adhesion-promoting primer should be sprayed onto the scuffed surface. A suitable primer is the two-part catalyzed product known as DPX-801 plastic adhesive primer made by PPG Industries of Strongsville, Ohio.

Interlayer primer use here should be based upon the same time-interval consideration just discussed above, and an appropriate interlayer primer is the mentioned System 251 primer.

Thus, a preferred and best mode manner of practicing the methodology of the present invention, described in several slightly different versions with respect to what is shown in FIG. 2, have been presented herein. This methodology relates to applying, to an outside surface of a liquid container, an anti-leak, self-healing, anti-projectile-puncture, layered barrier structure intended to inhibit liquid leakage from the container due to an impacting and piercing projectile. The methodology includes the steps of (a) spray-applying to the mentioned container surface a first barrier layer formed of a high-elastomeric material, (b) thereafter, spray applying to the first barrier layer a second, composite-material barrier layer including a body formed of substantially the same high-elastomeric material used in the first barrier layer, and a distribution in that body of a plurality of liquid-imbiber bead elements designed to react with dimensional swelling and related liquid absorption when contacted by any leakage fluid coming from the mentioned container, and (c) thereafter, spray-applying to the second barrier layer a third barrier layer formed of substantially the same high-elastomeric material used in the mentioned first barrier layer, and in the body of the second, composite barrier layer.

Accordingly, while the preferred methodology, in three such slightly differing versions, have been illustrated and described herein, it will be appreciated by those skilled in the art that variations and modifications may be made regarding practice of the present invention without departing from its spirit as such is set forth in the claims herein.

1. A method for applying to an outside surface of a liquid hydrocarbon container an anti-leak, self-healing, anti-projectile-puncture, layered barrier structure intended to inhibit liquid hydrocarbon leakage from the container due to an impacting and piercing projectile, said method comprising
spray applying to the mentioned container surface a first barrier layer formed of a high-elastomeric material,
thereafter, spray applying to the first barrier layer, within an interlayer spray interval of less than about four hours, a second, composite barrier layer including a body formed of substantially the same high-elastomeric material used in the first barrier layer, and a distribution in that body of a plurality of liquid-imbiber bead elements designed to react with dimensional swelling and related hydrocarbon liquid absorption when contacted by any leakage hydrocarbon fluid coming from the mentioned container, and
thereafter, spray-applying to the second barrier layer, within an interlayer spray interval of less than about four hours, a third barrier layer formed of substantially the same high-elastomeric material used in the mentioned first barrier layer, and in the body of the second, composite barrier layer.

2. The method of claim 1, wherein said spray-applying steps are carried out so as to provide the first and third barrier layers with substantially the same, common layer thickness, and the second barrier layer with substantially one-half the thickness of the mentioned same layer thickness.

3. The method of claim 1, wherein (a) the mentioned high-elastomeric material is formed from a blended pair of precursor material parts, (b) blending of these parts takes place upstream from where spray applying takes place to create each of the mentioned, three barrier layers, and (c) with respect to creation of the second barrier layer, plural hydrocarbon liquid-imbiber bead elements are pre-blended with at least one of the mentioned precursor material parts, with said pre-blending occurring at a location which is upstream from where blending of the precursor material parts takes place.

4. The method of claim 2, wherein (a) the mentioned high-elastomeric material is formed from a blended pair of precursor material parts, (b) blending of these parts takes place upstream from where spray applying takes place to create each of the mentioned, three barrier layers, and (c) with respect to creation of the second barrier layer, plural hydrocarbon liquid-imbiber bead elements are pre-blended with at least one of the mentioned precursor material parts, with said pre-blending occurring at a location which is upstream from where blending of the precursor material parts takes place.

5. A method for applying to an outside surface of a liquid hydrocarbon container an anti-leak, self-healing, anti-projectile-puncture, layered barrier structure intended to inhibit liquid hydrocarbon leakage from the container due to an impacting and piercing projectile, said method comprising
spray applying to the mentioned container surface a first barrier layer formed of a high-elastomeric material,
thereafter, spray applying to the first barrier layer, within an interlayer spray interval of less than about four hours, a second, composite barrier layer including a body formed of substantially the same high-elastomeric material used in the first barrier layer, and a distribution in that body of a plurality of liquid-imbiber bead elements designed to react with dimensional swelling and related hydrocarbon liquid absorption when contacted by any leakage hydrocarbon fluid coming from the mentioned container, and
thereafter, spray-applying to the second barrier layer, within an interlayer spray interval of less than about four hours, a third barrier layer formed of substantially the same high-elastomeric material used in the mentioned first barrier layer, and in the body of the second, composite barrier layer,
wherein said spray-applying steps are carried out so as to provide the first and third barrier layers with substantially the same, common layer thickness, and the second barrier layer with substantially one-half the thickness of the mentioned same layer thickness.

6. The method of claim 5, wherein (a) the mentioned high-elastomeric material is formed from a blended pair of precursor material parts, (b) blending of these parts takes place upstream from where spray applying takes place to create each of the mentioned, three barrier layers, and (c) with respect to creation of the second barrier layer, plural hydrocarbon liquid-imbiber bead elements are pre-blended with at least one of the mentioned precursor material parts, with said pre-blending occurring at a location which is upstream from where blending of the precursor material parts takes place.
